(19) United States
(12) Patent Application Publication
(10) Pub. No.: US 2020/0094361 A1
(43) Pub. Date: Mar. 26, 2020

(54) MACHINING SYSTEM

(71) Applicant: FANUC CORPORATION, Yamanashi (JP)

(72) Inventor: Saneyuki KAWABE, Yamanashi (JP)

(73) Assignee: FANUC CORPORATION, Yamanashi (JP)

(21) Appl. No.: 16/547,807

(22) Filed: Aug. 22, 2019

(30) Foreign Application Priority Data
Sep. 20, 2018 (JP) 2018-175489

(51) Int. Cl. B23Q 1/03; B25B 1/24; B25B 5/14

(52) U.S. Cl. CPC B23Q 1/035; B25B 5/14; B25B 1/2421

(57) ABSTRACT

A machining system includes: a robot; a control unit that controls the robot according to an operation program; a workpiece supply part to which a workpiece is supplied; a detection unit that detects the position of the supplied workpiece; a position correcting unit that corrects take-out position information in the operation program, according to the detected position; and a machining device that machines the workpiece taken out from the workpiece supply part. The workpiece supply part includes a fixing jig detachably holding the workpiece between a pair of holding surfaces. The fixing jig includes, in at least one of the holding surfaces, a number of pins that are arrayed parallel to each other to be individually movable in axial directions thereof and that can be fixed at arbitrary positions in the axial directions to conform to the surface shape of the workpiece with which distal ends thereof are in contact.

### CROSS-REFERENCE TO RELATED APPLICATION

This application is based on Japanese Patent Application No. 2018-175489, the content of which is incorporated herein by reference.

### FIELD

The present invention relates to a machining system.

### BACKGROUND

In the related art, there is a known support assembly that includes: a plurality of pins that are supported so as to be movable in the axial directions thereof; and a thin plate spring that deters, with a frictional force, movement of the pins, at an arbitrary position, wherein the pins are moved so as to form a recessed section having a shape complementary to the surface shape of a workpiece to be supported (for example, see Japanese Unexamined Patent Application, Publication No. Sho 63-278734).

### SUMMARY

One aspect of the present invention is directed to a machining system including: a robot that is provided with a hand capable of holding a workpiece; a control unit that controls the robot according to an operation program; a workpiece supply part to which the workpiece is supplied by the robot; a first detection unit that detects the position of the workpiece supplied to the workpiece supply part; a first position correcting unit that corrects take-out position information in the operation program of the control unit, according to the position of the workpiece detected by the first detection unit; and a machining device that machines the workpiece taken out from the workpiece supply part by the hand, wherein the workpiece supply part includes a first fixing jig that detachably holds the workpiece between a pair of first holding surfaces; and the first fixing jig includes, in at least one of the first holding surfaces, a plurality of pins that are arrayed parallel to each other so as to be individually movable in axial directions thereof and that can be fixed at arbitrary positions in the axial directions so as to conform to a surface shape of the workpiece with which distal ends thereof are in contact.

### BRIEF DESCRIPTION OF DRAWINGS

FIG. 1 is a view showing the overall configuration of a machining system according to one embodiment of the present invention.

FIG. 2 is a perspective view showing a state in which a workpiece is fixed to a fixing jig that is provided in a workpiece supply part of the machining system shown in FIG. 1.

FIG. 3 is a perspective view showing a state in which distal ends of a plurality of pins provided in a holding surface of the fixing jig shown in FIG. 2 are aligned.

FIG. 4 is a perspective view showing a state in which the distal ends of the pins shown in FIG. 3 are moved so as to conform to the surface shape of the workpiece.

FIG. 5 is a perspective view showing a state in which the workpiece is fixed to a fixing jig that is provided in a machining device of the machining system shown in FIG. 1.

FIG. 6 is a perspective view showing a state in which distal ends of a plurality of pins provided in a holding surface of the fixing jig shown in FIG. 5 are aligned.

FIG. 7 is a perspective view showing a state in which the distal ends of the pins shown in FIG. 6 are moved so as to conform to the surface shape of the workpiece.

FIG. 8 is a perspective view showing an example of the workpiece supply part of the machining system shown in FIG. 1.

FIG. 9 is a perspective view for explaining a step of detecting the position of the workpiece supplied to the fixing jig in the workpiece supply part shown in FIG. 8.

FIG. 10 is a perspective view for explaining a state in which the workpiece held by a hand mounted on a robot of the machining system shown in FIG. 1 is supplied to the fixing jig in the machining device.

FIG. 11 is a perspective view for explaining a step of detecting the position of the workpiece supplied in FIG. 10.

FIG. 12 is a perspective view for explaining a step of fixing the workpiece that has been machined by the machining device of the machining system shown in FIG. 1, to another fixing jig in the workpiece supply part.

FIG. 13 is a perspective view showing a modification of FIG. 10.

### DETAILED DESCRIPTION

A machining system 1 according to one embodiment of the present invention will be described below with reference to the drawings.

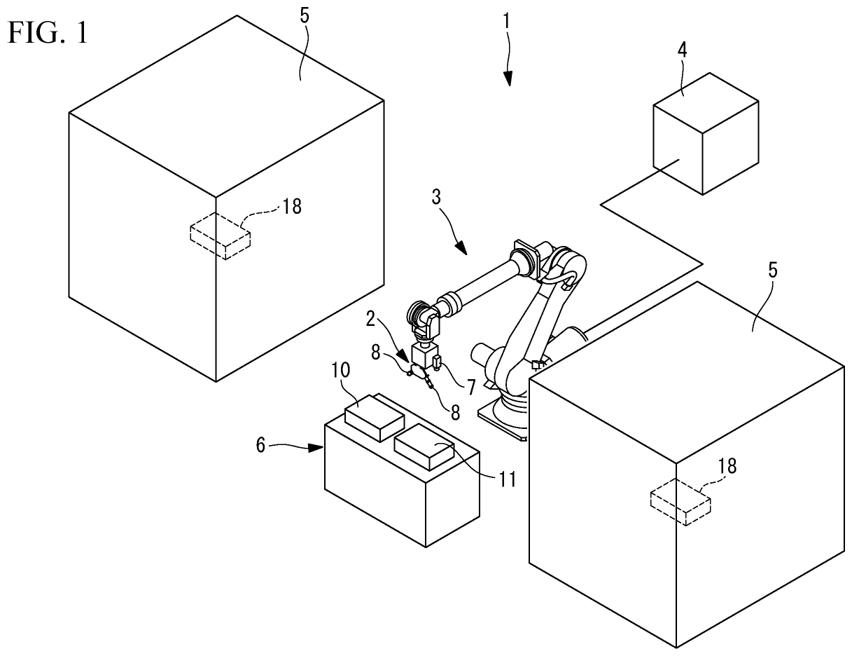

As shown in FIG. 1, the machining system 1 of this embodiment includes: a robot 3 that has, at a wrist tip thereof, a hand 2 capable of holding a workpiece W; a control device 4 that controls the robot 3; machining devices 5 that are disposed in the vicinities of the robot 3 and that machine the workpiece W; a workpiece supply part 6 on which a workpiece W that is supplied for the robot 3 is temporarily placed and on which the workpiece W that has been machined by the machining devices 5 is placed; and a camera (first detection unit) 7 that is mounted on the hand 2.

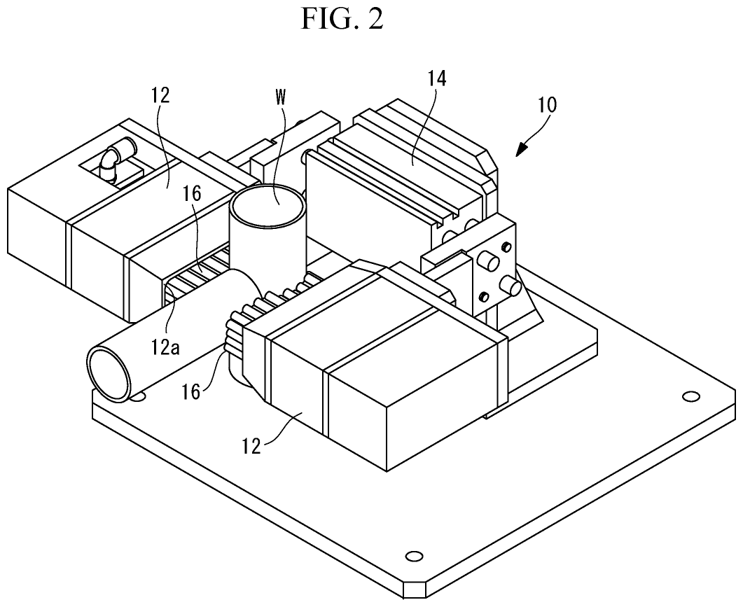

As shown in FIG. 2, the workpiece W is formed into, for example, a T-shape by joining column-shaped pipes. The shape of the workpiece W is not limited thereto.

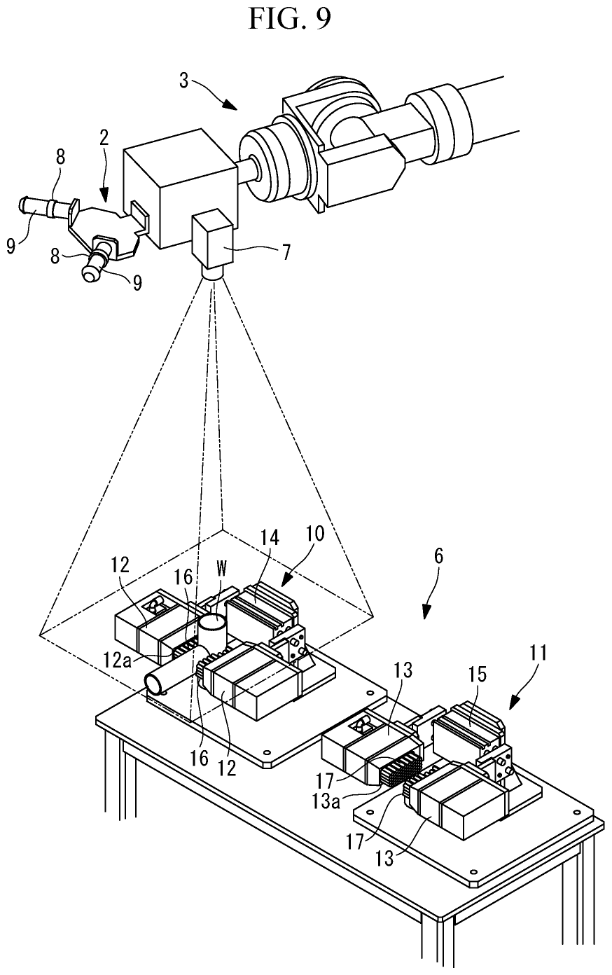

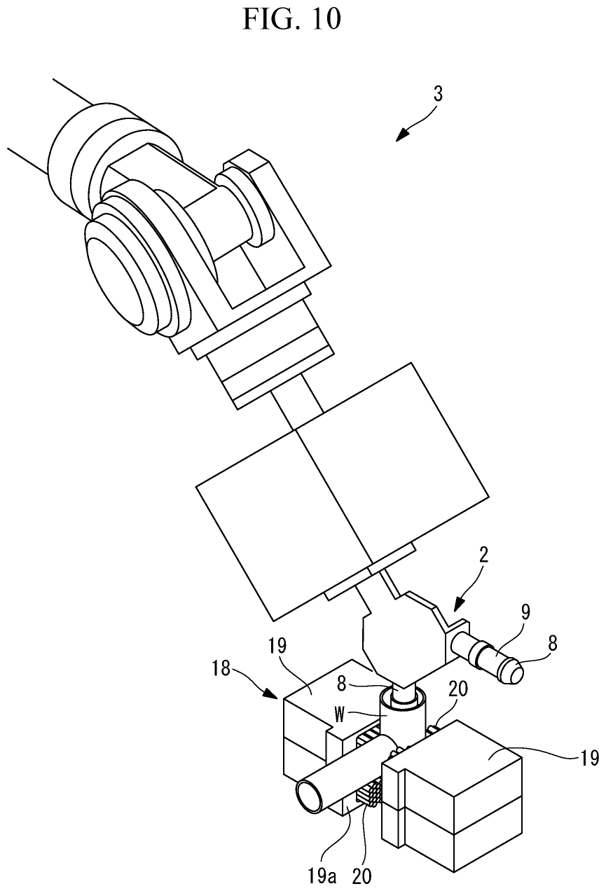

The robot 3 is, for example, a 6-axis articulated type robot. As shown in FIG. 9, the hand 2 includes, for example, two column-shaped holding parts 8 which can be inserted into the pipes, which constitute the workpiece W. Each of the holding parts 8 has, at a section thereof in the length direction, a balloon part 9 that is capable of expanding and contracting. In a state in which the holding part 8 is inserted into one of the pipes, the balloon part 9 is made to expand, thus bringing the balloon part 9 into close contact with an inner surface of the pipe and making it possible to easily hold the workpiece W. The structure of the hand 2 is not limited thereto, and it is also possible to adopt an arbitrary structure suitable for the shape of the workpiece W.

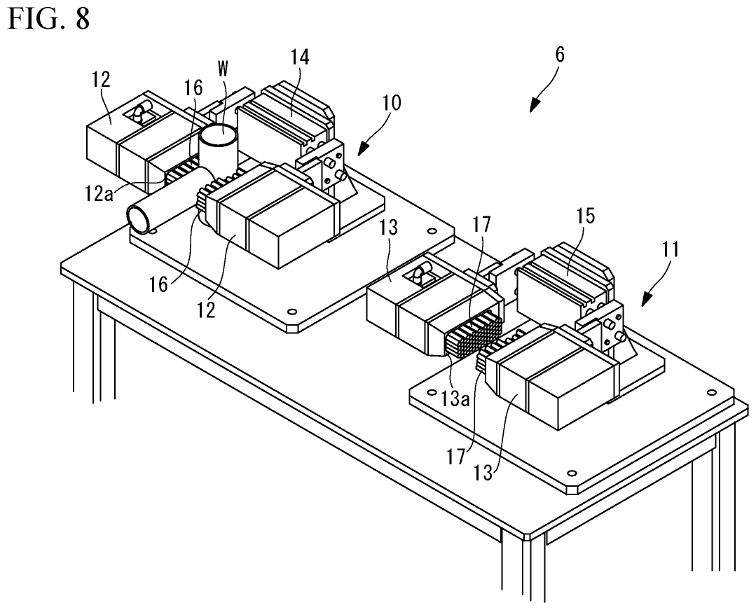

As shown in FIG. 8, the workpiece supply part 6 includes two fixing jigs 10 and 11 that are disposed side by side on a table.

The fixing jig (first fixing jig) 10 is used to temporarily fix a workpiece W that is supplied for the robot 3. The fixing jig 11 is used to fix the workpiece W that has been machined and that has been taken out from the machining device 5.

As shown in FIG. 2, the fixing jig 10 includes: a pair of holding members 12 that are moved close to and away from each other in the horizontal direction and that hold the workpiece W therebetween; and a cylinder 14 that drives the holding members 12 in the horizontal direction. The fixing jig 11 includes: a pair of holding members 13 that are moved close to and away from each other in the horizontal direction and that hold the workpiece W therebetween; and a cylinder 15 that drives the holding members 13 in the horizontal direction. In the holding members 12, a plurality of pins 16 that extend in the horizontal direction are two-dimensionally arrayed, in each of holding surfaces (first holding surfaces) 12a that are opposed to each other, in a direction along a vertical plane. In the holding members 13, a plurality of pins 17 that extend in the horizontal direction are two-dimensionally arrayed, in each of holding surfaces 13a that are opposed to each other, in a direction along a vertical plane. The pins 16 in the respective holding surfaces 12a are disposed such that distal ends thereof are opposed to each other, and the pins 17 in the respective holding surfaces 13a are disposed such that distal ends thereof are opposed to each other.

Furthermore, the pins 16 and 17 are supported in the corresponding holding members 12 and 13 so as to be individually movable in the axial directions thereof, are each constantly biased toward the distal end thereof by a spring (not shown), and can be fixed at arbitrary positions in the axial directions thereof by a fixing mechanism (not shown).

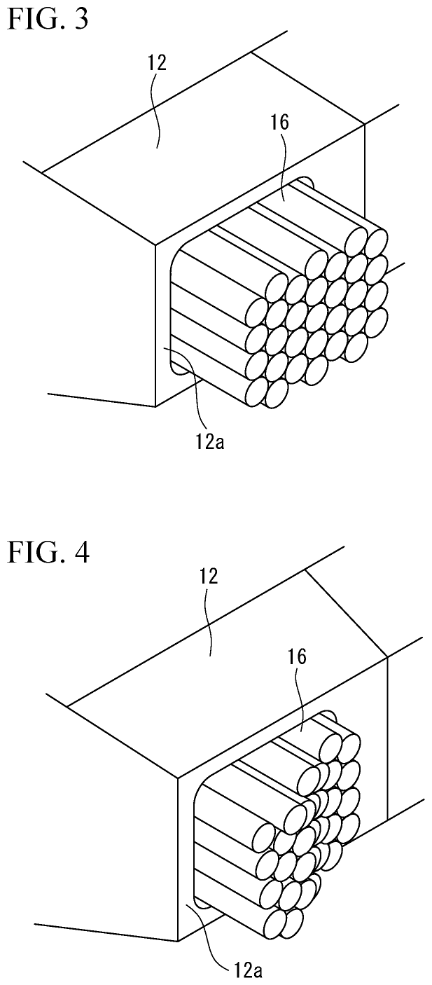

Specifically, in a state in which the fixing mechanism is released, the respective pins 16 and 17 are pushed toward the distal ends thereof by the springs, thus being arrayed such that the distal ends thereof are aligned, as shown in FIG. 3. As shown in FIG. 2, when the workpiece W is disposed between the holding surfaces 12a or the holding surfaces 13a, and the corresponding cylinder 14 or 15 is driven to move the corresponding holding members 12 or 13 close to each other, the workpiece W is held between the distal ends of the pins 16 or 17 in the pair of holding surfaces 12a or 13a. At this time, the respective pins 16 or 17, which are in contact with the workpiece W, are pushed rearward in the axial directions, thus being moved so as to conform to the surface shape of the workpiece W, as shown in FIG. 4. Then, the respective pins 16 or 17 are kept, by the fixing mechanism, at the positions after movement. FIG. 3 and FIG. 4 show, as an example, the holding surface 12a in the fixing jig 10.

The control device 4 has an operation program stored therein, the operation program being created through separate teaching etc., and the control device 4 includes a control unit (not shown) that controls the robot 3 according to the operation program. The operation program stores take-out positions at which the workpiece W is taken out from the fixing jigs 10 and 11. Furthermore, the control device 4 includes: an image processing unit (not shown) that detects the position of the workpiece W by processing an image acquired by the camera 7; and a position correcting unit (first position correcting unit, second position correcting unit) (not shown) that corrects the corresponding take-out position stored in the operation program, on the basis of the position of the workpiece detected by the image processing unit.

The image processing unit and the position correcting unit may be constituted by a processor that is separate from that of the control device 4 or by the same processor as that of the control device 4.

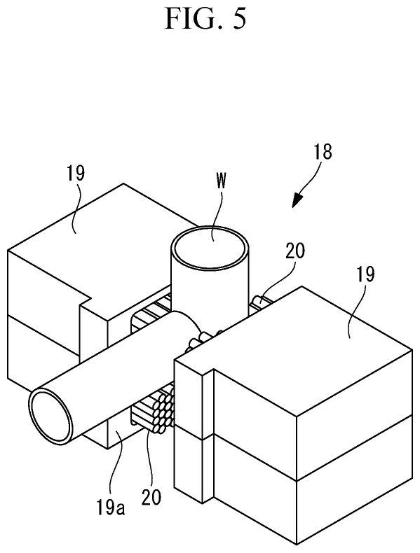

As shown in FIG. 5, the machining devices 5 are each provided with a fixing jig (second fixing jig) 18 that is the same as the fixing jigs 10 and 11 in the workpiece supply part 6.

As shown in FIG. 5, the fixing jig 18 is also provided with a pair of holding members 19 that are moved close to and away from each other in the horizontal direction and that hold the workpiece W therebetween. The respective holding members 19 are fixed to a main shaft of the machining device 5 and are moved close to or away from each other.

In the holding members 19, a plurality of pins 20 that extend in the horizontal direction are two-dimensionally arrayed, in each of holding surfaces (second holding surfaces) 19a that are opposed to each other, in a direction along a vertical plane. The pins 20 in the respective holding surfaces 19a are disposed such that distal ends thereof are opposed to each other.

Furthermore, the respective pins 20 are supported in the holding members 19 so as to be individually movable in the axial directions thereof, are each constantly biased toward the distal end thereof by a spring (not shown), and can be fixed at arbitrary positions in the axial directions thereof by a fixing mechanism (not shown).

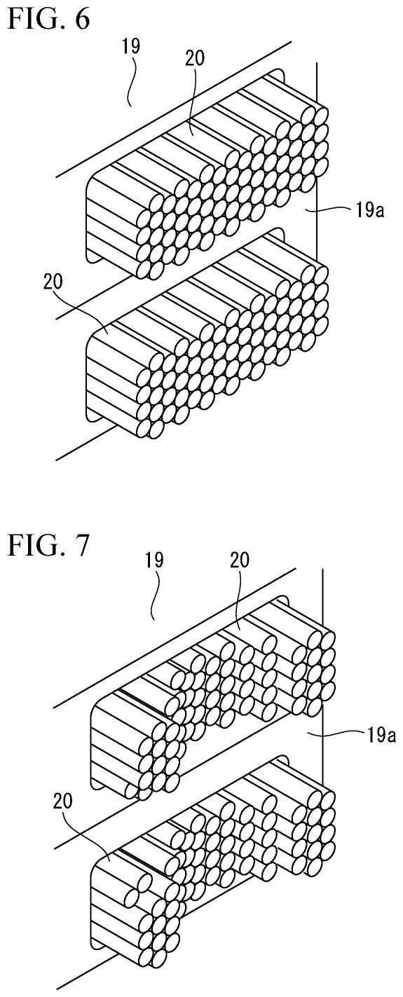

Specifically, in a state in which the fixing mechanism is released, the respective pins 20 are pushed toward the distal ends thereof by the springs, thus being arrayed such that the distal ends thereof are aligned, as shown in FIG. 6. As shown in FIG. 5, when the workpiece W is disposed between the holding surfaces 19a, and the holding members 19 are moved close to each other, the workpiece W is held between the distal ends of the pins 20 in the pair of holding surfaces 19a. At this time, the respective pins 20, which are in contact with the workpiece W, are pushed rearward in the axial directions, thus being moved so as to conform to the surface shape of the workpiece W, as shown in FIG. 7. Then, the respective pins 20 are kept, by the fixing mechanism, at the positions after movement.

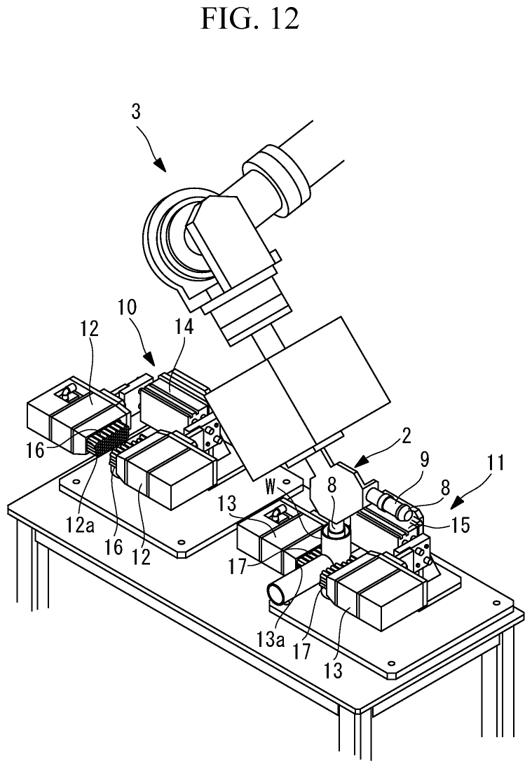

As shown in FIG. 11, the machining devices 5 are each provided with a touch probe (second detection unit) 21 that is brought into contact with the workpiece W, thereby making it possible to accurately detect the position of the workpiece W.

Then, the machining device 5 includes a second position correcting unit (not shown) that corrects machining-position information on the basis of the position of the workpiece W detected by the touch probe 21, and can apply machining to the workpiece W, in a state in which the workpiece W is held by the fixing mechanism, on the basis of the corrected machining-position information.

The operation of the thus-configured machining system 1 of this embodiment will be described below.

In order to machine the workpiece W by using this embodiment, the workpiece W is supplied to the fixing jig 10, which is one of the fixing jigs in the workpiece supply part 6. The workpiece W may be supplied by means of the robot 3 or may be manually supplied by an operator.

If the operator manually supplies the workpiece W, in a state in which the pair of holding members 12 are moved apart through driving of the cylinder 14 and in a state in which the fixing mechanism is released, thus aligning the distal ends of the pins 16, as shown in FIG. 3, the operator disposes the workpiece W between the holding members 12. In this state, when the cylinder 14 is driven to move the pair of holding members 12 close to each other, as a result of the holding members 12 moving while the pins 16 in contact with the surface of the workpiece W are stopped at their respective positions, the pins 16 move rearward in the axial directions relative to the holding members 12.

Accordingly, the respective pins 16 are disposed at such positions as to conform to the surface shape of the workpiece W, as shown in FIG. 4; therefore, in this state, the fixing mechanism is operated to fix the pins 16 with respect to the holding members 12, thereby making it possible to form, with the distal ends of the pins 16, such shapes of the holding surfaces 12a as to fix the workpiece W by being in close contact with the surface of the workpiece W.

In this state, the robot 3 is operated, and an image of the workpiece W fixed to the fixing jig 10 is acquired by means of the camera 7, which is mounted at the distal end of the robot 3. The image processing unit processes the acquired image of the workpiece W, thereby detecting the take-out position of the workpiece W. In this embodiment, because any one of the column-shaped holding parts 8 of the hand 2, which is mounted at the distal end of the robot 3, is inserted into one of the pipes of the workpiece W to hold the workpiece W, the take-out position is the center position of an inner hole of the pipe. In a case in which the inner hole of the pipe has a round shape, the center position of the inner hole and a tilt direction can be detected from the shape of the inner hole in the image.

The position correcting unit corrects the take-out position in the operation program of the robot 3 on the basis of the center position of the inner hole and the tilt direction of the workpiece W, which are detected by the image processing unit. Accordingly, when the robot 3 takes out the workpiece W, the holding part 8 of the hand 2 can be tilted in accordance with the tilt direction of the workpiece W and can be precisely inserted into the pipe.

Specifically, according to the machining system 1 of this embodiment, there is an advantage in that it is not necessary to supply the workpiece W to the fixing jig 10 in the workpiece supply part 6 in a precisely positioned state, and it is sufficient that an operator supplies the workpiece W with a certain degree of precision.

In this state, the balloon part 9 of the hand 2 is made to expand to bring the outer circumferential surface of the balloon part 9 into close contact with the inner surface of the inner hole of the workpiece W, thus making it possible to easily hold the workpiece W. Then, the cylinder 14 is driven to move the pair of holding members 12 away from each other, thus releasing the workpiece W and allowing the robot 3 to transfer the workpiece W. At this time, if the state of the pins 16 being fixed by the fixing mechanism is maintained, when workpieces W that have the same shape as the workpiece W are fixed to the fixing jig 10 from the next time, the workpieces W can be fixed at the same position in a positioned state.

The robot 3 holds the workpiece W and transfers the workpiece W from the fixing jig 10 in the workpiece supply part 6 to the fixing jig 18 in the machining device 5. When the pair of holding members 19 are moved apart, and the robot disposes the workpiece W between the pair of holding surfaces 19a that are in a state in which the fixing mechanism is released, the holding members 19 are moved close to each other, and the workpiece W is held between the pair of holding surfaces 19a. In this case, because the pins 20 whose distal ends are in contact with the surface of the workpiece W are kept at their respective positions regardless of the movement of the holding members 19, each of the pins 20 is disposed at a position to which the pin 20 has been individually moved in the axial direction with respect to the holding member 19, and, as shown in FIG. 7, the shapes of the holding surfaces 19a are formed so as to conform to the surface shape of the workpiece W, and the workpiece W is fixed so as not to move.

In this case, because the workpiece W is supplied to the fixing jig 18 in the machining device 5 by means of the robot 3, it is possible to precisely supply the workpiece W to the fixing jig 18.

In this state, the state of the workpiece W being held by the hand 2 is released, and the robot 3 is operated to retract the hand 2 from the workpiece W. Next, as shown in FIG. 11, the touch probe 21 in the machining device 5 is operated to bring the touch probe 21 into contact with a predetermined position of the workpiece W. Accordingly, the position of the workpiece W is detected, and, if there is an error with respect to the position of the workpiece W that is stored in advance in the machining device 5, the stored position of the workpiece W is corrected. As a result, the workpiece W can be precisely machined by the machining device 5.

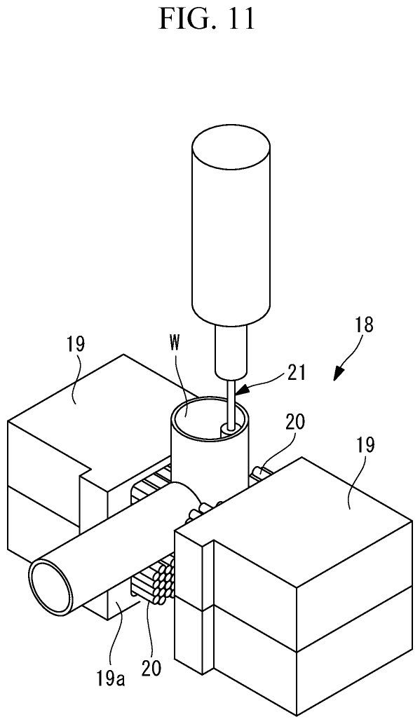

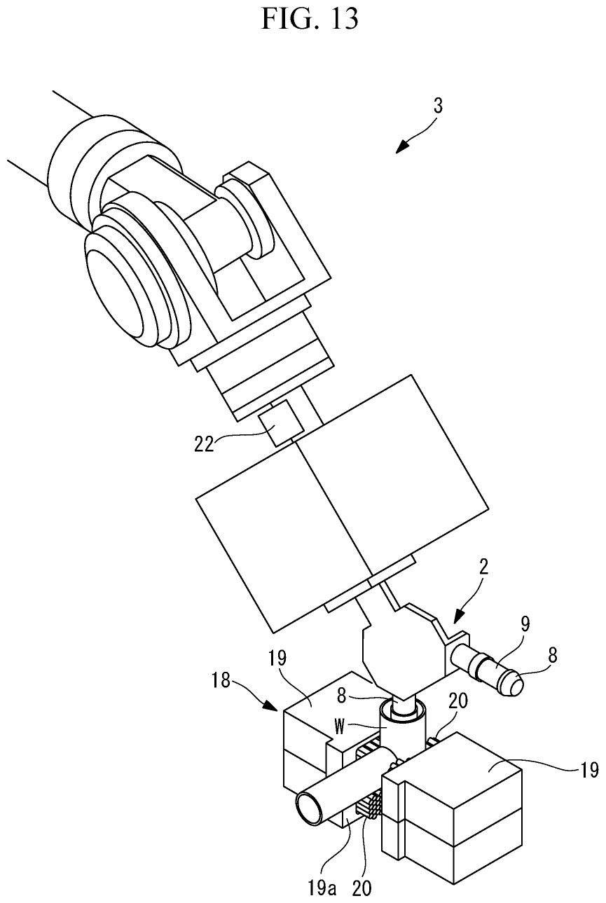

After the workpiece W is machined in the machining device 5, as shown in FIG. 10, the robot 3 is operated to insert the holding part 8 of the hand 2 into the pipe and to make the balloon part 9 expand, and the pair of holding members 19 are moved apart, thereby releasing the workpiece W fixed to the fixing jig 18 and allowing the robot 3 to take out the workpiece W. The workpiece W taken out from the machining device 5 by means of the robot 3 is fixed to the fixing jig 11 in the workpiece supply part 6, as shown in FIG. 12, in the same manner as to the fixing jig 10.

At this time, if the state of the pins 20 being fixed by the fixing mechanism is maintained, when workpieces W that have the same shape as the workpiece W are fixed to the fixing jig 18 from the next time, the workpieces W can be fixed at the same position in a positioned state.

In this way, according to the machining system 1 of this embodiment, after the workpiece W is fixed to the fixing jig 10, which has a number of pins 16, at an appropriate position and in an appropriate orientation, an image acquired by the camera 7 is processed to detect the take-out position and the orientation of the workpiece W; thus, there is an advantage in that high-precision positioning is not required in supplying the workpiece W to the workpiece supply part 6. Specifically, there is an advantage in that it is also possible for an operator to manually supply the workpiece W thereto.

Furthermore, because the fixing jig 18, which has a number of pins 20, is provided in the machining device 5, the workpiece W can be firmly fixed even if the shape of the workpiece W is changed. Then, the position of the workpiece W, in a state in which the workpiece W is fixed to the fixing jig 18, is precisely detected by the touch probe 21, and the position of the workpiece W stored in the machining device 5 is corrected; thus, there is an advantage in that the workpiece W can be precisely machined.

Note that, in this embodiment, as shown in FIG. 13, it is also possible to provide, between the robot 3 and the hand 2, a force sensor 22 that detects an external force applied to the hand 2. In the fixing jig 18 in the machining device 5, in a state in which the positions of the distal ends of the pins 20 are stored, if a workpiece W that has a different shape is supplied, the force sensor 22 detects an external force different from the normal force. In this case, the fixing mechanism is released to allow the pins 20 to be moved, the workpiece W is again sandwiched between the holding members 19, and the positions of the pins 20 are set again.

Furthermore, in this embodiment, although a description has been given of an example case in which a number of pins 16, 17, or 20 are arrayed in both of the pair of the holding surfaces 12a, 13a, or 19a of the fixing jigs 10, 11, or 18, instead of this, it is also possible to array the pins 16, 17, or 20 in only one of the pair of the holding surfaces 12a, 13a, or 19a.

As a result, the above-described embodiment leads to the following aspect.

One aspect of the present invention is directed to a machining system including: a robot that is provided with a hand capable of holding a workpiece; a control unit that controls the robot according to an operation program; a workpiece supply part to which the workpiece is supplied by the robot; a first detection unit that detects the position of the workpiece supplied to the workpiece supply part; a first position correcting unit that corrects take-out position information in the operation program of the control unit, according to the position of the workpiece detected by the first detection unit; and a machining device that machines the workpiece taken out from the workpiece supply part by the hand, wherein the workpiece supply part includes a first fixing jig that detachably holds the workpiece between a pair of first holding surfaces; and the first fixing jig includes, in at least one of the first holding surfaces, a plurality of pins that are arrayed parallel to each other so as to be individually movable in axial directions thereof and that can be fixed at arbitrary positions in the axial directions so as to conform to a surface shape of the workpiece with which distal ends thereof are in contact.

According to this aspect, when a workpiece is supplied to the workpiece supply part, the workpiece is sandwiched and fixed between the pair of first holding surfaces of the first fixing jig, which is provided in the workpiece supply part. In this case, the distal ends of the plurality of pins, which are arrayed parallel to each other in at least one of the first holding surfaces of the first fixing jig, are brought into contact with the surface of the workpiece, thereby moving the positions of the distal ends of the pins in the axial directions of the pins so as to conform to the surface shape of the workpiece, and the first holding surface is fixed at a position where a shape complementary to the surface shape of the workpiece is formed. Accordingly, even when the workpiece is supplied, between the first holding surfaces, in an arbitrary orientation and at an arbitrary position, it is possible to fix the workpiece at the supplied position so as not to move.

Then, the first detection unit is operated to detect the position of the workpiece that is in such a state as to be fixed to the first fixing jig, and the first position correcting unit corrects the take-out-position information in the operation program of the control unit, thereby allowing the robot to precisely hold, with the hand, the workpiece that is in such a state as to be fixed to the first fixing jig and to take out the workpiece from the workpiece supply part. Specifically, because it is not necessary to supply, to the first fixing jig, the workpiece in a precisely positioned state, and it is sufficient to supply the workpiece at an approximate position and in an approximate orientation, it is possible to save the operator trouble. Then, the robot transfers and hands over the taken-out workpiece to the machining device, thereby making it possible to precisely apply machining to the workpiece by means of the machining device.

In the above-described aspect, the machining device may be provided with a second fixing jig that detachably holds the workpiece between a pair of second holding surfaces; and the second fixing jig may be provided with, in at least one of the second holding surfaces, a plurality of pins that are arrayed parallel to each other so as to be individually movable in axial directions thereof and that can be fixed at arbitrary positions in the axial directions so as to conform to the surface shape of the workpiece with which distal ends thereof are in contact.

With this configuration, even when the shapes of workpieces are individually different, each of the workpieces can be fixed by the second fixing jig and can be precisely machined. Specifically, when the robot disposes the workpiece, which is held by the hand, between the second holding surfaces of the second fixing jig, the pair of second holding surfaces are moved close to each other, thus holding the workpiece between the second holding surfaces. In this case, the distal ends of the plurality of pins, which are arrayed parallel to each other in at least one of the second holding surfaces of the second fixing jig, are brought into contact with the surface of the workpiece, thereby moving the positions of the distal ends of the pins in the axial directions of the pins so as to conform to the surface shape of the workpiece, and the second holding surface is fixed at a position where a shape complementary to the surface shape of the workpiece is formed. Accordingly, even when the shapes of workpieces are individually different, each of the workpieces can be fixed at the supplied position so as not to move.

Furthermore, in the above-described aspect, the machining device may be provided with: a second detection unit that detects the position of the workpiece fixed to the second fixing jig; and a second position correcting unit that corrects machining-position information on a machining position where machining is performed by the machining device, according to the position of the workpiece detected by the second detection unit.

With this configuration, the second detection unit is operated to detect the position of the workpiece that is in such a state as to be fixed to the second fixing jig, and the second position correcting unit corrects the machining-position information on the position where machining is performed by the machining device, thereby allowing the machining device to precisely machine the workpiece that is in such a state as to be fixed to the second fixing jig.

According to the present invention, an advantageous effect is afforded in that a plurality of kinds of workpieces having various surface shapes can be machined, without requiring high-precision positioning when such a workpiece is mounted on a jig.

1. A machining system comprising:
a robot that is provided with a hand capable of holding a workpiece;
a control unit that controls the robot according to an operation program;
a workpiece supply part to which the workpiece is supplied for the robot;
a first detection unit that detects a position of the workpiece supplied to the workpiece supply part;
a first position correcting unit that corrects take-out position information in the operation program of the control unit, according to the position of the workpiece detected by the first detection unit; and
a machining device that machines the workpiece taken out from the workpiece supply part by the hand,
wherein the workpiece supply part includes a first fixing jig that detachably holds the workpiece between a pair of first holding surfaces; and
the first fixing jig includes, in at least one of the first holding surfaces, a plurality of pins that are arrayed parallel to each other so as to be individually movable in axial directions thereof and that can be fixed at arbitrary positions in the axial directions so as to conform to a surface shape of the workpiece with which distal ends thereof are in contact.

2. The machining system according to claim 1,
wherein the machining device includes a second fixing jig that detachably holds the workpiece between a pair of second holding surfaces; and
the second fixing jig includes, in at least one of the second holding surfaces, a plurality of pins that are arrayed parallel to each other so as to be individually movable in axial directions thereof and that can be fixed at arbitrary positions in the axial directions so as to conform to the surface shape of the workpiece with which distal ends thereof are in contact.

3. The machining system according to claim 2, wherein the machining device includes: a second detection unit that detects the position of the workpiece fixed to the second fixing jig; and a second position correcting unit that corrects machining-position information on a machining position where machining is performed by the machining device, according to the position of the workpiece detected by the second detection unit.
